(19) United States
(12) Patent Application Publication
(10) Pub. No.: US 2006/0159798 A1
(43) Pub. Date: Jul. 20, 2006

(54) Method for producing mould parts by injection and plugged needle nozzle for an injection mould

(76) Inventors: Herbert Gunther, Allendorf (DE); Ulrich Stieler, Goslar (DE)

Correspondence Address: CLARK & BRODY, 1090 VERMONT AVENUE, NW, SUITE 250, WASHINGTON, DC, 20005, US

(21) Appl. No.: 10/545,944

(22) PCT Filed: Feb. 11, 2004
(86) PCT No.: PCT/EP04/01265

§ 371 Date: Feb. 3, 2006

(30) Foreign Application Priority Data
Feb. 11, 2003 (DE) 103 05 756.0

(51) Int. Cl. B29C 45/23

(52) U.S. Cl. 425/564

(57) ABSTRACT

The invention relates to a needle-sealed nozzle (10) for an injection mould whose injection nozzle (20) for introducing a fluid molten material (S) into a mould cavity (50) can be sealed on the end thereof by a closing needle (30). Said closing needle is provided with an injection channel (60) extending to an outlet orifice (62) for injecting a fluid (F) into the molten material (s) which is introduced into the mould cavity. Said outlet orifice is formed on the end face (34) of the closing needle for the molten material and can be closed by a fluid closing needle (64) which is axially displaceable in the closing needle for the molten material (30) can be moved from an opening position to a first and second closing position by a drive (40) For this purpose, the cylindrical closing part (33) of the closing needle (30) enters, in an accurately adjusted manner, a sealing seat (D) which is preferably formed in the injection nozzle (20) or in the end bit (23) of the nozzle. In order to inject a fluid, theclosing needle for the molten material (30) is placed in the first closing position and extends by the end thereof on the nozzle side towards the mould cavity (50) in such a way that the outlet orifice (62) for fluid (F) reaches the molten material (S) introduced in the mould cavity (50). The fluid being injected, the molten material (S) is extracted from the injection nozzle (20), if necessary and introduced in an injection hole (I) created by the fluid injection. For this purpose, the closing needle for the molten material (30) is displaced to the second closing position, the injection hole (I) being closed with the supplied molten material (s).

The invention relates to a method for producing mould parts by injection according to the preamble of claim 1 and a plugged needle nozzle for an injection mould to perform said method according to the preamble of claim 12.

Injection moulded parts having sections of different wall thickness often present the problem that thicker areas need more time than thinner or flatter areas to cool down in their interior. As a result, shrinkage may appear in areas which have not sufficiently solidified yet, causing them to detach from the wall of the mould cavity or even producing sink marks. This in turn results in the formation of voids and vacuoles on the finished injection moulded part.

In order to prevent this, it is known, after the injection of a molten material into a mould cavity, to introduce a gas or a liquid, hereinafter generally referred to as fluid, into the still flowable melt so as to cause the formation of a hollow space in the injection moulded part. The injected fluid applies a pressure on the injection moulding material, thus causing it to get in contact with the walls of the mould until the injection moulding material has reached a sufficient stiffness. In this way, the contours or the mould cavity are accurately reproduced. Moreover, the fluid cools the melt from inside and thus contributes to a fast solidification even of the thicker areas of the injection moulded part. Shrinkages are efficiently avoided. The cycle time of the injection moulding machine may be increased.

For fluid injection, a hollow needle is typically introduced at a predetermined point of the mould cavity, allowing the fluid to flow into the mould cavity (see e.g. EP 0 421 842 B1). However, this method presents the disadvantage that the finished injection moulded part will exhibit visible points of injection in addition to the gate marks. Dependent on the particular application, this is not always desirable.

For this reason, the document DE 42 31 270 A1 proposes to provide a hot runner nozzle having an axially displaceable shut-off needle in a melt channel in such manner that the fluid (here: a gas) is supplied via the shut-off needle which is movable via a drive into an open position and into a closed position. To this end, said shut-off needle comprises a centrical longitudinal bore whose nozzle-side end terminates in an outlet gap (annular gap) having a width of less than 0.1 mm, and whose other end is connected with a gas pressure duct. Once the shut-off needle has closed the melt channel, i. e. after the injection of the plastic melt, the gas required for the gas assisted injection procedure is immediately fed through the gate of the mould cavity into the plastic melt. The very narrow annular gap ensures that the plastic melt cannot enter the gas channel due to its surface tension.

There is no longer need for a separate hollow needle. Here, too, the fluid will in advertently leave at the gate point a visible injection opening which is in some cases objectionable. Another problem is the fact that the shut-off needle and hence the fluid outlet gap are always positioned ahead of the cavity boundary. For this reason, the shut-off needle and the mould must seal absolutely tight to prevent the gas from escaping elsewhere or searching another passage. In particular, there is the risk that the fluid flows between the injected material and the walls of the mould cavity. This may result in uncontrolled deformations or premature detachment of the injection moulded part from the mould, leading to an increased scrap rate. It is a further disadvantage that the fluid flow is limited by the invariability of the outlet gap in the shut-off needle.

The same applies to a hot runner injection moulding system disclosed in DE 4004225 C2 and EP 0 385 175 B1. In these systems, however, the axially displaceable shut-off needle of the hot runner nozzle receives an elongated hollow needle which is firmly secured in the mould relative to the shut-off needle, and with the front outlet end permanently projecting through the gate into the mould cavity. The outlet end is formed by a porous steel portion made from stainless steel. The lafter allows for a direct fluid flow into the mould cavity and prevents the melt from entering the hollow needle. As the shut-off needle is opened, the melt flows around the outlet end. Simultaneously, a quantity of fluid is injected into the melt flow. This results in the formation of a gas bubble or liquid bubble which expands until the melt abuts the walls of the mould cavity and a solid outer skin has formed. Then the shut-off needle is closed, the fluid pressure is reduced, and the finished injection moulded part is ejected.

In order to avoid an injection hole produced by the gas flow and liquid flow, respectively, it is known from DE 199 47 984 A1 to close such hole once formed in the injection moulded part due to the injection of the plastic melt of the injection fluid into the mould cavity, by introducing a small quantity of plastic material into the melt. For this purpose, the melt shut-off needle is reopened for a short time after the injection of the fluid in order to allow a further quantity of melt to enter from the melt channel. Then the shut-off needle is moved back into its closed position, with the result that a plastic plug is pushed into the injection hole. A substantially smooth surface is generated at the injection point and gate point, respectively. In order to introduce the injection fluid, an injection channel is formed in the melt shut-off needle. Said injection channel terminates on the end face of the melt shut-off needle and can be closed there by a further axially displaceable needle. The melt channel and the fluid channel, i. e. the melt shut-off needle and the fluid shut-off needle can be opened and closed alternately.

In this case, it is likewise a disadvantage that the outlet opening for the injection fluid is always upstream of the cavity boundary so that the fluid must find a passage through the gate into the mould cavity. This takes much time and is not always successful. Moreover, the hot runner nozzle forms part of the mould cavity, i.e. the nozzle body which is maintained at the highest possible temperature down into the nozzle tip is in direct contact with the cold mould. This results in a poor thermal separation and thermal expansions. As a consequence, leakages may occur and impair the melt and fluid flows.

Another embodiment disclosed in DE 199 47 984 A1 provides a hollow needle for the fluid which is arranged in the melt shut-off needle in an axially displaceable manner and comprises at its end facing the mould cavity an elongated hollow injection needle which for fluid injecton is introduced from out of the melt shut-off needle into the mould cavity of the injection mould. Although the fluid is thus directly fed into the plastic melt, there is the risk during the insertion of the hollow needle into the mould cavity that its lateral outlet openings get stuck at the outer skin which has already formed on the injection moulded part in the marginal areas of the gate so as to pull off the injection moulded part from the walls of the mould cavity. Furthermore, the fluid outlet openings in the hollow needle are only closed when they are completely retracted into the melt shut-off needle. Thus the fluid is only allowed to escape after the hollow needle has reached its end position in the mould cavity. For this reason, the fluid outlet openings must be dimensioned narrow enough to prevent the plastic melt from entering the fluid channel due to the high pressure of the melt. Hence, the fluid flow is limited and is adjustable, if at all, via the pressure in the hollow needle. All in all, this entails high expenditures for production and control.

It is an object of the invention to overcome these and further drawbacks found in the prior art and to provide a method for producing mould parts by injection which allows an injection fluid of any quantity to be directly supplied into the still flowable melt in the mould cavity and ensures that the melt is efficiently prevented from entering the fluid channel, even with large-dimensioned fluid outlet openings. After the fluid injection, the injection hole thereby produced in the injection moulded part shall be closed, if need be. An appropriate device for an injection mould for performing this method should be cost-efficient, include simple means and ensure a constantly reliable and efficient fluid injection. A further object is good thermal separation between the injection nozzle and the mould.

Main features of the invention are stated in the characterizing portions of claim 1 and claim 12. Embodiments form the subject-matter of claims 2 to 11 and 13 to 30.

A method for producing injection moulded parts in an injection mould includes the introduction of a flowable melt into a mould cavity by means of an injection nozzle which can be closed at its end by a shut-off needle. Once the injection nozzle is closed, a pressurized fluid is injected through the shut-off needle into the melt that has been introduced into the mould cavity, with the result that the fluid forms a hollow space within the still flowable melt. An injection hole will remain on the injection moulded part. The invention provides that the shut-off needle closes the injection nozzle after the introduction of the melt into the mould cavity and is inserted with its nozzle-side end into the mould cavity. Then the fluid is introduced in the area of the nozzle-side end of the shut-off needle into the melt which has been fed into the mould cavity, at least one outlet opening on the nozzle-side end of the shut-off needle being opened for the fluid exit and being closed again after an at least partial pressure relief in the hollow space.

By inserting the shut-off needle into the mould cavity, the fluid is directly injected into the melt without any loss of time, with the result that the cycle times are improved. Also, the fluid cannot escape otherwise or flow between the injection moulded part and the walls of the mould cavity, so that the scrap rate is extremely low. Moreover, the melt cannot flow into the injection channel during the introduction of the shut-off needle into the mould cavity, since the outlet opening provided on the nozzle-side end of the shut-off needle can be closed and is only opened after the shut-off needle has been introduced into the mould cavity. Hence, the outlet opening may be of nearly any design. In particular, it may have a relatively large cross-section, for example in order to allow a great quantity of fluid to flow into the melt within a relatively short time. There is no longer need for a separate injection needle or hollow injection needle which immerses into the mould cavity and the melt which has been injected into the mould cavity, respectively, i. e. the injection moulded part, which may already be solidified in the marginal areas of the gate, cannot deteriorate.

According to claim 2, the shut-of needle is introduced through the gate in the injection mould into the mould cavity, and claim 3 provides that an outlet opening for the fluid can only be opened after the melt shut-off needle has reached a defined or definable end position, preferably a closed position, in the mould cavity. Thus, the outlet opening cannot be opened unintentionally. The melt is also efficiently prevented during the introduction of the shut-off needle into the mould cavity from flowing into the fluid outlet opening which may have any dimension desired. Said outlet opening is blocked, and thus closed, until the shut-off needle has reached its end position in the mould cavity. After this, however, the fluid is injected into the melt without any delay and relatively fast owing to the large outlet opening. The operational reliability is very high, and compared to the presently known methods, the cycle times are significantly reduced. According to claim 4, the shut-off needle remains in a first closed position in the mould cavity during the fluid injection. Alternatively, for example, it may already be retracted from the mould cavity during the closing process of the outlet opening, with a further positive effect on the cycle time.

After the introduction of the fluid, the injection nozzle may according to claim 5 be opened again for a short time so as to allow a further quantity of melt to flow into the injection hole. Then the shut-off needle is moved back into a second closed position, with the injection hole being closed by the subsequently supplied melt. Claim 6 further provides that the melt which has been subsequently supplied into the injection hole by the shut-off needle is adhesively connected with the not yet fully solidified injection moulded part, and thus tightly closes the injection hole. It cannot be reopened even at a later time, i. e. the fluid remaining in the injection moulded part cannot escape.

The embodiment of claim 7 provides that the shut-off needle is moved into a position in which it matches the outline of the injection moulded part after the reopening of the injection nozzle in the second closed position. In particular, according to claim 8, the shut-off needle may be positioned in its second closed position with its nozzle-side end abutting the cavity boundary of the mould cavity. Thus the injection moulded part gets a substantially smooth surface after the closure of the injection hole, and it hardly differs from conventionally manufactured injection moulded parts. One can hardly find visual evidence of the former existence of the injection hole. The injection moulded parts manufactured according to the method of the invention fulfil even high aesthetical demands.

According to claim 9, opening and closing of the injection nozzle and the outlet opening are freely controllable and/or programmable by a control device, i. e. small effort will be required for introducing the fluid as well as the melt. Expediently the introduction of the melt into the mould cavity and/or into the injection hole as well as the introduction of the fluid into the melt are, according to claim 10, performed dependent on at least one parameter. This allows for the adaptation of the complete procedure to various basic conditions at any time, with the result that the cost-effectiveness of the process is improved. According to claim 11, the preferred parameters to be determined are pressure, temperature and time. Such values are easily and quickly determined, so that the procedure may be modified even at a later time, if required.

With a plugged needle nozzle for an injection mould for producing injection moulded parts, comprising an injection nozzle for introducing a flowable melt into a mould cavity, comprising a shut-off needle for opening and closing the injection nozzle and comprising an injection channel extending in the shut-off needle for introducing a fluid into the melt which has been introduced into the mould cavity, the injection channel terminating in an outlet opening adapted to be opened or closed alternatively or alternately with the injection nozzle, the invention provides according to claim 12 that the shut-off needle comprises in the area of the nozzle-side end a substantially cylindrical shut-off part which engages in first and second closed positions of the shut-off needle into a substantially cylindrical sealing seat, with the shut-off needle for the fluid injection projecting, in the first closed position, with its nozzle-side end far enough into the mould cavity so that the outlet opening for the fluid is situated in the melt which has been introduced into the mould cavity.

Thus the outlet opening for the fluid is only opened when it is situated in the melt, i. e. the fluid is directly introduced into the melt and can quickly form the required hollow space there. Also, the fluid cannot search another passage or even escape since the shut-off needle always immerses into the mould cavity and remains there during the fluid injection. Thermal expansions of the injection nozzle and/or the injection mould are not critical. Hence, there are no particular requirements with respect to the tightness of the mould inserts and the injection mould, respectively. The design-engineering efforts are significantly reduced. Simultaneously, the outlet opening may be individually dimensioned dependent on the particular application so that nearly any fluid flow may be introduced into the melt.

With respect to the production, it is advantageous if the outlet opening for the fluid is formed according to claim 13 at the nozzle-side end of the melt shut-off needle, in particular if it is inserted, according to claim 14, into the outer end face of the melt shut-off needle.

In order to prevent the melt from flowing into the injection channel, claim 15 provides that the outlet opening for the fluid can be closed by a fluid shut-off needle which is axially displaceable in the injection channel of the melt shut-off needle whose outlet opening forms, according to claim 16, a substantially cylindrical sealing seat for the fluid shut-off needle. Thus the melt shut-off needle acts as a fluid injection nozzle immersing into the melt which has been injected into the mould cavity, with the dimension of the outlet opening being freely selectable, e.g. for generating a large fluid flow in the melt. The latter cannot escape during the introduction of the melt shut-off needle into the mould cavity. In contrast to the prior art, there is also no need for a premature fluid flow which might, for example, keep the outlet opening free. In fact, the fluid is always introduced in an optimal quantity only at the place where it is intended to act, namely in the melt. The consumption cost is just as low as the design-engineering effort whereby the production and operational costs are favourably influenced.

Claim 17 provides another embodiment in which the injection channel is formed in a hollow needle which is axially displaceable in a melt shut-off needle and comprises at its nozzle-side end at least one outlet opening for the fluid. Said outlet opening is preferably laterally located in the hollow needle so that it is sufficient, in contrast to the prior art, to extract it only a little bit from the melt shut-off needle for opening. For closing, the hollow needle is retracted into the melt shut-off needle whose end forms, according to claim 18, a sealing seat for the hollow needle.

The development of claim 19 provides that in closed position, the fluid shut-off needle or the hollow needle, respectively, is flush with the end face of the melt shut-off needle. Consequently, there are no cavities or undercuts where the melt might stick. There is no need for particular cleaning or maintenance work. Moreover, the melt shut-off needle leaves, in its second closed position, a smooth surface on the injection moulded part as the injection opening is closed so that the injection moulded part is free of visual blemishes.

In order to prevent premature opening of the fluid shut-off needle by improper handling or control, the movement of the fluid shut-off needle or the hollow needle, respectively, can be stopped according to claim 20 by means of a blocking device. According to claim 21, the latter is coupled with the movement of the melt shut-off needle, i. e. the outlet opening for the fluid is for example blocked until the melt shut-off needle has reached its end position in the mould cavity. Only at that moment will the fluid shut-off needle and/or its drive be released by the blocking device so the fluid is allowed to flow directly into the melt.

According to claim 22, the sealing seat for the melt shut-off needle is formed on or in the injection nozzle. Claim 23 further provides at least one infeed cone for the melt shut-off needle, which cone is arranged along the longitudinal axis of the injection nozzle and the shut-off needle, respectively, ahead of the sealing seat. Said shut-off needle is always centred before it is introduced into the sealing seat, whereby the friction-induced wear of the sealing seat and the melt shut-off needle is significantly reduced and a permanently optimal sealing effect is ensured.

The method of claim 24, according to which a pre-chamber is formed between the injection nozzle and the injection mould composed of at least two mould inserts provides good thermal separation between the injection nozzle, which is generally heated down into the nozzle tip, and the injection mould which is relatively cold, or in the case of a cold channel relatively warm, compared to the injection nozzle. Thermal expansions of the injection nozzle will not be transmitted to the mould cavity, and vice versa.

Claim 25 provides that the melt shut-off needle for the fluid injection projects through a gate into the mould cavity, with the gate being formed, according to claim 26, in the mould inserts of the mould cavity, and having, according to claim 27, a conical form. As the melt shut-off needle dives into the mould cavity, it will not directly contact the mould inserts but the melt in the gate and in the pre-chamber. Wear is further significantly reduced. The entire hot runner nozzle has an all-in-all long service life.

According to claim 28, a further embodiment of the hot runner nozzle according to the invention provides a centring body made from a wear-resistant material which is arranged between the injection nozzle and the mould cavity composed of at least two mould inserts, with the centring body, according to claim 29, having at least one infeed cone for the melt shut-off needle. On the one hand, the centring body provides a permanently precise guiding for the melt shut-off needle and on the other hand, it provides the required thermal separation between the injection nozzle and the mould. Therefore it is expedient, according to claim 30, to form the sealing seat for the melt shut-off needle in the centring body.

Further features, details and advantages will become apparent from the wording of the claims and from the following description of embodiments by way of the drawings wherein:

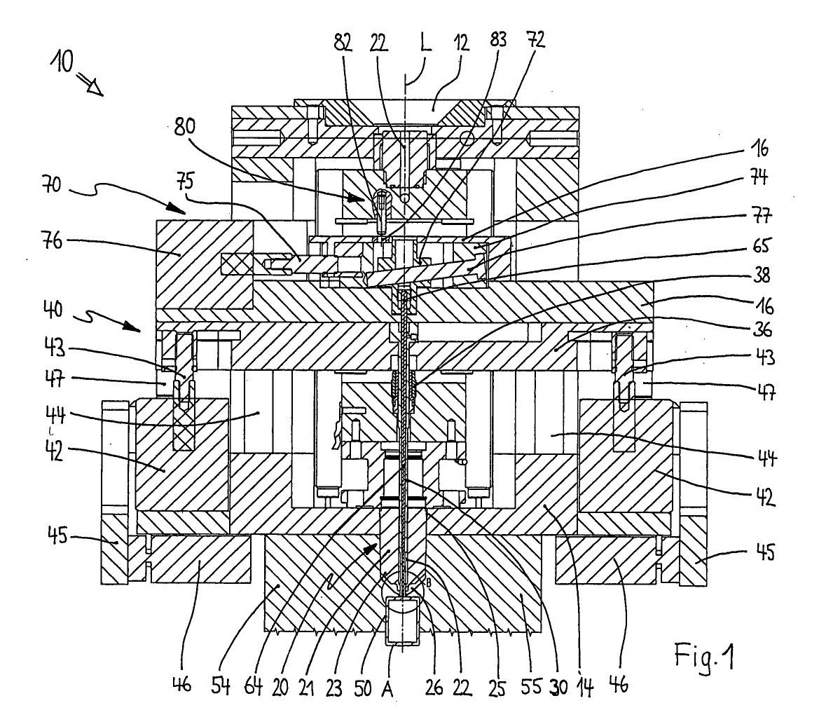

FIG. 1 is a sectional view of a plugged needle nozzle for an injection moulding machine,

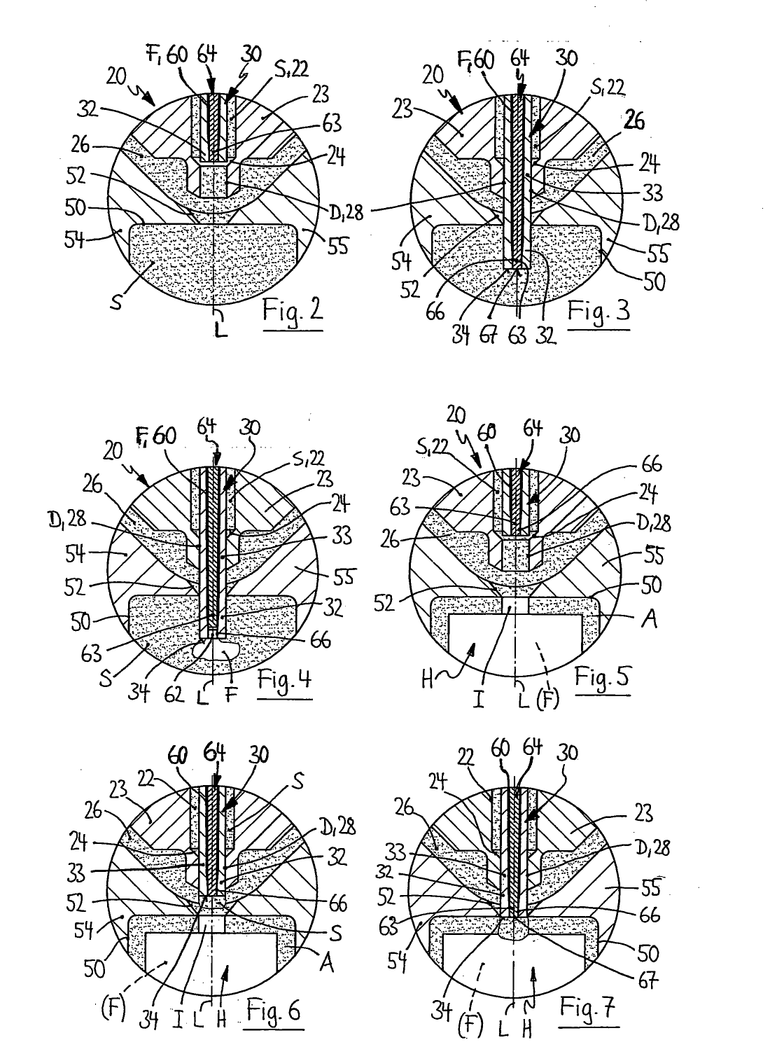

FIG. 2 is an enlarged partial view of the plugged needle nozzle of FIG. 1 with the melt shut-off needle open,

FIG. 3 is an enlarged partial view of the plugged needle nozzle of FIG. 1 with the melt shut-off needle in a first closed position,

FIG. 4 is an enlarged partial view of the plugged needle nozzle of FIG. 1 with the fluid shut-off needle open,

FIG. 5 is an enlarged partial view of the plugged needle nozzle of FIG. 1 with the melt shut-off needle reopened,

FIG. 6 is an enlarged partial view of the plugged needle nozzle of FIG. 1 with the melt shut-off needle closing again, and

FIG. 7 is an enlarged partial view of the plugged needle nozzle of FIG. 1 with the melt shut-off needle in a second closed position.

The plugged needle nozzle, in FIG. 1 generally designated by the reference numeral 10, is designed for producing injection moulded parts A according to the gas assisted injection procedure. It is used in an injection moulding machine (not shown) and comprises a melt channel 22 under temperature which communicates via an inlet opening 12 with a machine nozzle or a manifold of the injection moulding machine and which extends through several moulding plates (not specified) into an injection nozzle 20. The latter includes a preferably externally heated nozzle body 21 which is mounted by a flanged edge 25 into a moulding plate 14 and comprises or forms at its end a nozzle tip 23 which may be formed as an integral unit with the nozzle body 21. Alternatively, it consists of a highly thermally conductive material and is inserted, preferably screwed, from the bottom side into the nozzle body 21.

A melt, for example a metal, silicone or plastic melt, is supplied via the melt channel 22 and the injection nozzle 20 into a mould cavity 50 for further processing. Said mould cavity 50 is formed between two mould inserts 54, 55 which are mounted by means of screws (not shown) onto a moulding plate 14 and delimit concentrically with respect to the longitudinal axis L of the hot channel nozzle 10 a conical gate 52. A pre-chamber 26 is formed between the mould inserts 54, 55 and the nozzle tip 23 of the injection nozzle 20, which separates the heated melt channel 22 and the injection nozzle 20, respectively, from the generally cool mould inserts 54, 55.

An axially displaceable shut-off needle 30 is provided for opening and closing the injection nozzle 20 and the melt channel 22 formed therein as the shut-off needle is moved by a pneumatic drive 40 from an open position into two determinable closed positions. For the purpose, it is concentrically located in the melt channel 22 of the injection nozzle 20, and is connected at its end with a stroke plate 36 suitable to be lifted and lowered steadily by two pneumatic cylinders 42 of the drive 40 and their actuators 43, the pneumatic cylinders 42 being arranged symmetrically relative to the longitudinal axis L of the shut-off needle 30. Four guide pins 44, also arranged symmetrically around the longitudinal axis L, ensure an accurate guidance of a stroke plate 36 in the plugged needle nozzle 10, whereas the axial guidance of the shut-off needle 30 is provided by a guide bushing 38 which also serves for sealing the melt channel 22 towards the outside.

In the area of its nozzle-side end, the at least sectionally cylindrical shut-off needle 30 which has several stepped diameter changes along its longitudinal axis L comprises a substantially cylindrical shut-off part 33 which, in either closed position of the shut-off needle 30, reaches into a substantially cylindrical sealing seat D in the injection nozzle 20 that is provided in the nozzle tip 23 with a cylindrical section 28 whose inner diameter is only slightly greater than the outer diameter of the shut-off part 33 of the shut-off needle 30. When the latter moves from its open position shown in FIG. 2 into one of its closed positions, the melt channel 22 in the injection nozzle 20 will be tightly sealed so as to prevent the melt S from escaping from the channel 22. An infeed cone 24 is formed along the longitudinal axis L ahead of the cylindrical section 28 in the nozzle tip 23 which centres the shut-off needle 30 during the closing process, thus preventing the shut-off needle 30 from striking the sealing seat D if it were deflected from its concentrical position in the melt channel 22.

In order to limit the movement of the stroke plate 26 in closing direction and to move the shut-of needle 30 in its two closed positions, there are at either side of the stroke plate 36 spacer blocks 47, spacer rings, or similar, which are adapted to move and/or swivel into the motion area of the stroke plate 38 by means of pneumatic actuating cylinders 46. If the spacer blocks 47 are outside the motion area of the stroke plate 38, the latter can travel downwards relatively far, as shown in FIGS. 3 and 4. Then the shut-off needle is in its first closed position and projects with its nozzle-side end 32 through the gate 52 into the mould cavity 50. If the spacer blocks 47 are swivelled in, however, the downward movement of the stroke plate 36 is limited. The shut-off needle 30 can be moved into its second closed position ahead of the mould cavity 50 and in particular be positioned at the cavity boundary of the latter (see FIG. 7).

The spacer blocks 44 are mounted to the actuating cylinders 46 by means of two support arms 45 and are adjustable in height by these or are self-adjustable whereby the respective final closed position of the shut-off needle 30 may be adjusted or modified as required.

The melt shut-off needle 30 is provided with an injection channel 60 for injecting a fluid F into the melt S which has been introduced into the mould cavity 50, said injection channel 60 being connected in the mould-side area with a pressure line (not shown), for example a gas pressure line, and terminating as an outlet opening 62 at the nozzle-side end 32 of the melt shut-off needle 30. The opening 62 is preferably a simple bore in the end face 34 of the melt shut-off needle 30, to be closed by a fluid shut-off needle 64 which is axially displaceable in the injection channel 60. For this purpose, the fluid shut-off needle 64 is adapted to be moved from an open position into a closed position by means of a pneumatic drive 70, with the mould-side end 65 of the substantially cylindrical fluid shut-off needle 64 being firmly secured in a guide bushing 72 which is mounted axially displaceable along the longitudinal axis L in a guide plate 16 of the plugged needle nozzle 10.

The guide bushing 72 is axially displaceable in a slide 74 which is mounted for perpendicular displacement with respect to the longitudinal axis L within the guide plate 16 and is connected with a pneumatic cylinder 76 of the drive 70 via an actuator 75. A screw 77 arranged in the slide 74 penetrates the guide bushing 72 at an angle oblique to the perpendicular line, so as to allow the guide bushing 72 to travel upwards and downwards in axial direction L during lateral movements of the slide 74. By such a sliding block guidance, the fluid shut-off needle 64 may be opened and closed independently of the melt shut-off needle 30.

For deliberate closure of the outlet opening 62, the melt shut-off needle 30 forms a substantially cylindrical sealing seat 66 for the all-in-all cylindrical fluid shut-off needle 64, with the inner diameter in the outlet opening 62 being inferior to that in the injection channel 60, so as to allow the fluid F to flow around the fluid shut-off needle 64 within the melt shut-off needle 30. In its closed position, the fluid shut-off needle 64 reaches with a cylindrical shut-off part 63 into the sealing seat 66, its end face 67 being flush with the end face 34 of the melt shut-off needle 30.

In order to avoid unintended opening of the fluid shut-off needle 64, it may be prevented from moving by a blocking device 80. The latter consists of a pin 82 which is fixed in the plugged needle nozzle 10, extends parallel to the longitudinal axis A and has a length such that it engages into a corresponding recess 83 in the slide 74 once the melt shut-off needle 30 leaves its first closed position. Due to the mechanic coupling, the slide 74 is prevented from moving laterally. The fluid shut-off needle 64 cannot be opened, neither unintentionally nor due to a handling error.

The principle of operation of the hot runner nozzle 10 according to the invention is shown in FIGS. 2 to 7. Initially, the melt shut-off needle 30 is in its open position. The melt S is free to flow through the melt channel 22, the cylindrical section 28 in the nozzle tip 23, the pre-chamber 26 and through the gate 52 into the mould cavity 50 (FIG. 2).

Once the mould cavity 50 is filled with a sufficient quantity of melt S, the melt shut-off needle 30 is moved into its first closed position by the drive 40, the nozzle-side end 32 of the melt shut-off needle 30 extending sufficiently far into the mould cavity 50 to place the outlet opening 62 for the fluid F in the melt S (FIG. 3). The infeed cone 24 in the nozzle tip 23 and the conical gate 52 ensure together with the melt S that the melt shut-off needle 30 is guided in an exactly concentrical manner with respect to the longitudinal axis L and is prevented from striking the nozzle 20 and/or the mould inserts 54, 55.

Once the melt shut-off needle 30 has reached its end position in the mould cavity 50, the blocking device 80 releases the drive 70 for the fluid shut-off needle 64. The outlet opening 62 for the fluid F is opened, whereas the fluid shut-off needle 64 is retracted into the melt shut-off needle 30. The pressurized fluid, for example an inert gas, is allowed to flow freely into the still flowable melt S (FIG. 4). This results in the formation of a hollow space H which presses the melt S against the inner face of the walls of the mould cavity.

Once the formation of the hollow space H is completed, the pressure of the fluid is reduced and the fluid shut-off needle 64 is closed. The melt shut-off needle 30 is retracted from the mould cavity 50, thus generating an injection channel I having the dimensions of the melt shut-off needle 30 in the already produced injection moulded part A. If said injection channel is to remain open, the melt shut-off needle 30 is moved into the second closed position, and the injection moulded part A is ejected. It is not strictly necessary that the shut-off needle 30 matches the contour of the injection moulded part A or is positioned at the cavity boundary.

If however the injection hole I is to be closed, the melt shut-off needle 30 is moved a second time into its open position so as to allow a small defined quantity of melt S to flow through the pre-chamber 26 into the mould cavity 50 (FIG. 5).

As shown in FIG. 6, the melt shut-off needle 30 is then closed again, so that the introduced melt S is pushed through the pre-chamber 26 and the gate 52 into the injection hole I until the melt shut-off needle 30 has reached its second closed position (FIG. 7). The subsequently supplied melt S closes the injection hole I by forming a firm compound with the also not yet quite solidified material which has been previously introduced. The shut-off needle 30 matches the outline of the injection moulded part A. Due to the aligned end faces 34, 67 of the shut-off needles 30, 64, the injection moulded part A will get a substantially smooth surface. The finished injection moulded part A is ready for ejection.

Each drive 40, 46, 70 is actuated by an electronic control device (not illustrated) which is freely programmable according to the particular application. Thus the injection nozzle 20 and the outlet opening 62 may be opened and closed individually and independently of each other. It is important, however, that the outlet opening 62 for the fluid F be opened and closed neither too late nor too early, dependent on the respective material of the melt. For this purpose, the fluid F is introduced into the melt S in relation to at least one parameter. Such a parameter may be the pressure of the melt in the mould cavity 50, its temperature or a defined time which is determined by appropriate measuring devices and transmitted to the control device.

The invention is not limited to any of the embodiments described above, but encompasses many variations and modifications. For example, the plugged needle nozzle may be a hot runner type or a cold runner type, with the injection nozzle 20 being externally heated or internally heated. Also, a liquid may be substituted for the gas which is introduced into the melt S. It is further conceivable that a second melt is injected through the shut-off needle 30.

Another embodiment provides that the injection channel 60 is formed in a hollow needle which is axially displaceable in the melt shut-off needle 30, the latter comprising at its nozzle-side end two lateral outlet openings 62 for the fluid F. The end of the melt shut-off needle 30 forms a sealing seat for the hollow needle. For opening the outlet openings 62, it is sufficient to retract the hollow needle a little bit from the melt shut-off needle.

The coupling of the blocking device 80 with the movement of the melt shut-off needle may also be of the electric type or the pneumatic type, with the drives 40, 70 for the shut-off needles 30, 64 being controlled accordingly. Dependent on the particular application, it may be advantageous to actuate said shut-off needles, just as the spacer blocks 47, by an electric motor or a servomotor. It is also conceivable to use a hydraulic drive.

In a further embodiment of the hot runner nozzle 10, a centring body (not illustrated) made from a wear-resistant material is arranged between the injection nozzle 20 and the two mould inserts 54, 55, said centring body comprising an infeed cone (not shown, either) and a sealing seat D for the melt shut-off needle 30.

It will be noted that the melt shut-off needle 30 forms an injection nozzle for the fluid F which may be introduced well into the mould cavity 50 and thus into the injected melt S. For this purpose, the plugged needle nozzle 10 for an injection mould for introducing a flowable melt S into a mould cavity 50 comprises an injection nozzle 20 whose end can be sealed by a shut-off needle 30. The latter is provided with an injection channel 60 terminating in an outlet opening 62 for introducing a fluid F into the melt S which has been injected into the mould cavity 50. Said outlet opening 62 is formed on the end face 34 of the melt shut-off needle 30 and can be closed by a fluid shut-off needle 64 which is axially displaceable in the melt shut-off needle 30.

The melt shut-off needle 30 can be moved from an open position into first and second closed positions by a drive 40. A cylindrical shut-off part 33 of the shut-off needle 30 engages with accurate fit into a sealing seat D which is preferably formed in the injection nozzle 20 or on a nozzle tip 23. For the fluid injection, the melt shut-off needle 30 is moved into its first closed position in which it projects with its nozzle-side end 32 sufficiently far into the mould cavity 50 that the outlet opening 62 for the fluid F is situated in the melt S which has been introduced into the mould cavity 50. If necessary, the injection nozzle 20 is opened for a short time after the fluid injection in order to supply a further quantity of melt S which is introduced through the injection hole I which has been produced by the fluid injection. Then the melt shut-off needle 30 is moved into its second closed position, whereupon the injection hole I is closed by the subsequently supplied quantity of melt S, thus providing the injection moulded part A with a substantially smooth surface.

All features and advantages evident from the claims, the description and the drawings, including design details, spatial arrangements and process steps, may be essential to the invention, both individually and in a great variety of combinations.

### REFERENCES

A injection moulded part
D sealing seat
F fluid
H hollow space
I injection hole
L longitudinal axis
S melt
10 plugged needle nozzle
12 inlet opening
14 moulding plate
16 guide plate
20 injection nozzle
21 nozzle body
22 melt channel
23 nozzle tip
24 infeed cone
25 flanged edge
26 pre-chamber
28 cylindrical section
30 melt shut-off needle
32 nozzle-side end
33 shut-off part (of 30)
34 end face
36 stroke plate
38 guide bushing
40 drive
42 pneumatic cylinder
43 actuator
44 guide pin
45 support arm/bracket
46 actuating cylinder
47 spacer block
50 mould cavity
52 Gate
54 mould insert
55 mould insert
60 fluid injection channel
62 outlet opening
63 shut-off part (of 60)
64 fluid shut-off needle
65 mould-side end
66 sealing seat
67 end face
70 Drive
72 guide bushing
74 Slide
75 Actuator
76 pneumatic cylinder
77 Screw
80 blocking device
82 pin
83 recess

1. Method for producing injection moulded parts (A) in an injection mould wherein a flowable melt (S) is introduced into a mould cavity (50) by means of an injection nozzle (20) suitable to be closed at its end by a shut-off needle (30), and wherein after the closure of the injection nozzle (20) a pressurized fluid (F) is injected through the shut-off needle (30) into the melt (S) that has been introduced into the mould cavity (50), with the fluid (F) forming a hollow space (H) in the still flowable melt (S), and wherein an injection hole (I) remains in the injection moulded part (A), characterised in that the shut-off needle (30) closes the injection nozzle (20) after the introduction of the melt (S) into the mould cavity (50) and is inserted with its nozzle-side end (32) into the mould cavity (50), and that the fluid (F) is then supplied in the area of the nozzle-side end (32) of the shut-off needle (30) into the melt (S) which has been introduced into the mould cavity (50), with at least one outlet opening (62) being opened on the nozzle-side end (32) of the shut-off needle (30) for releasing the fluid and being closed again after the pressure in the hollow space (H) has been relieved at least partially.

2. Method according to claim 1, characterised in that through a gate (52) provided in the mould cavity (50), the shut-off needle (30) is introduced into the mould cavity (50).

3. Method according to claim 1, characterised in that an outlet opening (62) for the fluid (F) can only be opened after the shut-off needle (30) has reached a defined or definable end position in the mould cavity (50).

4. Method according to claim 1, characterised in that the shut-off needle (30) remains in a first closed position in the mould cavity (50) during the introduction of the fluid.

5. Method according to claim 1, characterised in that the injection nozzle (20) is reopened for a short time after the introduction of the fluid so as to allow a further quantity of melt (S) to flow into the injection hole (I), and in that the shut-off needle (30) is then moved into a second closed position whereby the injection hole (I) is closed by the subsequently supplied melt (S).

6. Method according to claim 5, characterised in that the melt (S) which has been subsequently introduced into the injection hole (I) by the shut-off needle (30) is adhesively connected with the injection moulded part (A).

7. Method according to claim 5, characterized in that, after the injection nozzle (20) has been reopened in the second closed position, the shut-off needle (30) is moved into a position in which it matches the outline of the injection moulded part (A).

8. Method according to claim 5, characterised in that in the second closed position, the shut-off needle (30) is positioned with its nozzle-side end (32) abutting the cavity boundary of the mould cavity (50).

9. Method according to claim 1, characterised in that the opening and closing process of the injection nozzle (20) and the outlet opening (62) is freely controllable and/or programmable by means of a control device.

10. Method according to claim 9, characterised in that the introduction of the melt (S) into the mould cavity (50) and/or into the injection hole (I) as well as the introduction of the fluid (F) into the melt (S) is performed depending on at least one parameter.

11. Method according to claim 9, characterised in that the parameter or the parameters are pressure, temperature, time, or similar.

12. Plugged needle nozzle (10) for an injection mould for producing injection moulded parts, comprising an injection nozzle (20) for introducing a flowable melt (S) into a mould cavity (50), comprising a shut-off needle (30) for opening and closing the injection nozzle (20) and comprising an injection channel (60) extending in the shut-off needle (30) for introducing a fluid (F) into the melt (S) which has been introduced into the mould cavity (50), the injection channel (60) terminating in an outlet opening (62) adapted to be opened or closed alternatively or alternately with the injection nozzle (20), characterised in that the shut-off needle (30) comprises in the area of the nozzle-side end (32) a substantially cylindrical shut-off part (33) which engages in first and second closed positions of the shut-off needle (30) into a substantially cylindrical sealing seat (D), with the shut-off needle (30) for the fluid injection projecting, in the first closed position, with its nozzle-side end (32) sufficiently far into the mould cavity (50) so that the outlet opening (62) for the fluid (F) is situated in the melt (S) which has been introduced into the mould cavity (50).

13. Plugged needle nozzle according to claim 12, characterised in that the outlet opening (62) for the fluid (F) is formed at the nozzle-side end (32) of the melt shut-off needle (30).

14. Plugged needle nozzle according to claim 12, characterised in that the outlet opening (62) for the fluid (F) is provided at the outer end face (34) of the melt shut-off needle (30).

15. Plugged needle nozzle according to claim 12, characterised in that the outlet opening (62) for the fluid (F) can be closed by a fluid shut-off needle (64) which is axially displaceable in the injection channel (60) of the melt shut-off needle (30).

16. Plugged needle nozzle according to claim 15, characterised in that the melt shut-off needle (30) forms a substantially cylindrical sealing seat (66) for the fluid shut-off needle (64) in the outlet opening (62).

17. Plugged needle nozzle according to claim 12, characterised in that the injection channel (60) is formed in a hollow needle which is axially displaceable in the melt shut-off needle (30) and comprises at its nozzle-side end at least one outlet opening (62) for the fluid (F).

18. Plugged needle nozzle according to claim 17, characterised in that the end of the melt shut-off needle (30) forms a sealing seat for the hollow needle.

19. Plugged needle nozzle according to claim 12, characterised in that in closed position, the fluid shut-off needle (64) or the hollow needle, respectively, is flush with the end face (34) of the melt shut-off needle (30).

20. Plugged needle nozzle according to claim 12, characterised in that a blocking device (80) is provided for stopping the movement of the fluid shut-off needle (64) and the hollow needle, respectively.

21. Plugged needle nozzle according to claim 20, characterised in that the blocking device (80) for the fluid shut-off needle (64) or the hollow needle, respectively, is coupled with the movement of the melt shut-off needle (30).

22. Plugged needle nozzle according to claim 12, characterised in that the sealing seat (D) for the melt shut-off needle (30) is formed on or in the injection nozzle (20).

23. Plugged needle nozzle according to claim 12, characterised in that at least one infeed cone (24) for the melt shut-off needle (30) is arranged along the longitudinal axis (L) of the injection nozzle (20) ahead of the sealing seat (D).

24. Plugged needle nozzle according to claim 12, characterised in that a pre-chamber (26) is formed between the injection nozzle (20) and the mould cavity (50) which is composed of at least two mould inserts (54, 55).

25. Plugged needle nozzle according to claim 12, characterised in that the melt shut-off needle (30) for the fluid injection projects through a gate (52) into the mould cavity (50).

26. System according to claim 25, characterised in that the gate (52) is formed in the mould inserts (54, 55) of the mould cavity (50).

27. System according to claim 26, characterised in that the gate (50) has a conical design.

28. Plugged needle nozzle according to claim 12, characterised in that a centring body made from a wear-resistant material is arranged between the injection nozzle (20) and the mould cavity (50) which is composed of at least two mould inserts (54, 55).

29. Plugged needle nozzle according to claim 28, characterised in that at least one infeed cone for the melt shut-off needle (30) is formed in the centring body.

30. Plugged needle nozzle according to claim 28, characterised in that the sealing seat (D) for the melt shut-off needle (30) is formed in the centring body.
